(19) United States
(12) Patent Application Publication
(10) Pub. No.: US 2018/0322571 A1
(43) Pub. Date: Nov. 8, 2018

(54) SYSTEM AND METHOD FOR FACILITATING ELECTRONIC TRANSACTIONS

(71) Applicant: EINNOVATIONS HOLDINGS PTE. LTD., Singapore (SG)

(72) Inventors: Orlando B. VEA, Pasig City (PH); Angelito M. VILLANUEVA, Pasig City (PH); Agustin L. SANTIAGO, Pasig City (PH); Via Nazarena N. VILLAFUERTE, Pasig City (PH)

(73) Assignee: EINNOVATIONS HOLDINGS PTE. LTD., Singapore (SG)

(21) Appl. No.: 15/773,124

(22) PCT Filed: Nov. 4, 2016
(86) PCT No.: PCT/SG2016/050546

§ 371 Date: May 2, 2018

(30) Foreign Application Priority Data
Nov. 5, 2015 (SG) 10201509171S

(51) Int. Cl. G06Q 40/02; G06Q 30/02

(52) U.S. Cl. CPC G06Q 40/025; G06Q 30/02

(57) ABSTRACT

A system for aggregating a plurality of credit providers to provide credit to at least one consumer comprising a consumer device comprising an identifier associated with the at least one consumer; a central facilitator arranged to receive a request for credit from the consumer device; the request comprises the identifier associated with the at least one consumer; a whitelist database arranged in data communication with the central facilitator, the whitelist database further arranged to receive whitelist information from at least one of the plurality of credit providers; wherein upon receipt of a request for credit, the central facilitator instructs the whitelist database to compare the identifier with the whitelist information to determine if the at least one consumer is whitelisted, such that: if the at least one consumer is whitelisted, the at least one consumer is provided with a first electronic interface to complete an application for credit; if the at least one consumer is not whitelisted, the at least one consumer is provided with a second electronic interface for a plurality of identity checks.

### FIELD OF THE INVENTION

The present invention relates to a system and method for facilitating electronic transactions. In particular, the system and method are suited for the facilitation of loan transactions electronically and will be described in such context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

In most countries, obtaining a loan via an institutional loan provider, such as a bank, for example, require numerous documents including physical forms to be completed, proofs of income and/or other documentary requirements to be furnished. This makes the loan process not only frustrating but cumbersome to any person trying to obtain a loan. Further, a person taking up a loan usually has to be physically present to complete any documentary requirements. This is often inconvenient and time consuming. Such stringent and complex requirements may sometimes be factors for potential borrowers to turn to illegal money-lenders such as loan sharks, although these potential borrowers may well qualify for legal loans but put off by the complex procedures.

Currently, potential borrowers often have to seek different loan providers for different purposes. For example, a potential borrower requesting for a mortgage loan may have to seek a bank or financial institution A, the same potential borrower may have to seek another bank or financial institution B for a personal loan or automobile loan. This is often inconvenient and time consuming. In addition, each loan provider may have different requirements for obtaining a loan. In particular, different loan providers (e.g. banks) have different procedures, varying rates, complicated requirements, stringent credit scoring, and other process steps, to obtain different types of loans, get processed and the eventual grant and release of the loans.

While there currently exists various electronic loan facilitators that may assist or facilitate part of the loan process, there is at present no ‘one-stop’ platform for borrowers and loan providers to facilitate time and cost efficient loan transactions between a plurality of loan providers and users.

Further, there also exists a need to provide a secure ‘one-stop’ platform to facilitate loan transaction and reduce fraudulent activities.

### SUMMARY OF INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The invention is motivated by the need to simplify an entire loan origination and application process, as well as to support a loan process from a potential borrower's electronic device, such as, but not limited to, a smart mobile phone.

The invention is further motivated by the need to provide a loan origination platform that is aimed to be a one-stop-platform for all potential borrowers.

In addition, the invention seeks to provide credit providers such as financial institutions or banks, a marketplace where they can offer their loan products in a centralized platform where a bigger share of the customers will be going to thus allowing for equal opportunities from both borrowers (consumers) and credit providers (lenders) in a safe and secured environment.

The invention further seeks to encourage and allow borrowers to move from traditional loan channels to the digital or electronic channels, as the novel way of handling loan origination, and align the objectives of one or more financial institutions, such as a central bank, to promote digitization of banking transactions.

The ‘one-stop’ platform is not only a mobile-enabled (fully digital) loan platform for the private or non-government sector, but is conceived to be a marketplace of loans across physical or geographical boundaries.

In accordance with an aspect of the invention there is a system for facilitating loans comprising a central facilitator operable to receive an electronic request for loan; a plurality of loan providers, at least one loan provider in data communication with a whitelist database, the whitelist database containing information relating to a list of pre-approved eligible borrowers; wherein the central facilitator is further operable to identify whether the request for loan is processed by one of the plurality of loan providers and if so, exclude the remaining loan providers from processing the loan.

Preferably, the central facilitator comprises one or more servers, distributed or otherwise. The central facilitator may be hosted by, and arranged in data communication with a service provider, such as a telecommunications carrier. Another aspect of the invention relates to a method of facilitating loan comprising the steps of: detecting an identifier entered by a user; sending the identifier for processing by a central facilitator; receiving from the central facilitator a verification code; identifying if the user is a whitelisted user; prompting the user to select a loan provider; and wherein if the user is a whitelisted user, processing the user based on a pre-qualified requirements. Preferably, the identifier is a mobile identification number of the user.

Yet another aspect of the invention relates to a non-transitory computer readable medium containing executable software instructions thereon wherein when installed and executed on a mobile device of a user, performs a method comprising the steps of: detecting on the mobile device an identifier entered by the user; sending the identifier to a central facilitator for processing; receiving from the central facilitator a verification code; identifying if the user is a whitelisted user; prompting the user to select a loan provider; and wherein if the user is a whitelisted user, processing the user based on a pre-qualified requirements.

Another aspect of the invention relates to a system for aggregating a plurality of credit providers to provide credit to at least one consumer comprising a consumer device comprising an identifier associated with the at least one consumer; a central facilitator arranged to receive a request for credit from the consumer device; the request comprises the identifier associated with the at least one consumer; a whitelist database arranged in data communication with the central facilitator, the whitelist database further arranged to receive whitelist information from at least one of the plurality of credit providers; wherein upon receipt of a request for credit, the central facilitator instructs the whitelist database to compare the identifier with the whitelist information to determine if the at least one consumer is whitelisted, such that: if the at least one consumer is whitelisted, the at least one consumer is provided with a first electronic interface to complete an application for credit; if the at least one consumer is not whitelisted, the at least one consumer is provided with a second electronic interface for a plurality of identity checks.

In some embodiments, the system further comprises a network service provider arranged in data communication with the central facilitator to generate a verification token to be sent to the consumer device.

In some embodiments, the central facilitator comprises a credit provider interface to aggregate and generate information associated with each of the plurality of credit providers.

In some embodiments, the request for credit comprises a loan request, the loan request comprises a loan amount and loan term.

In some embodiments, upon receipt of the loan request, the central facilitator is operable to simulate an amortization schedule based on the loan amount and the loan term.

In some embodiments, the central facilitator is operable to send the simulated amortization schedule in an electronic form to the plurality of credit providers and the consumer. The central facilitator may be operable to log the time each of the plurality of credit providers replies with a loan offer associated with the simulated amortization schedule. In some embodiments, the credit provider that replies at the earliest time is selected to be the successful credit provider to make a loan offer, and the central facilitator is operable to send a first electronic notification to the successful and unsuccessful credit providers.

In some embodiments, the central facilitator is operable to send a second electronic notification to the consumer, the second electronic notification comprises the loan offer related to the successful credit provider, the central facilitator further operable to send a third electronic interface for the consumer to decide whether to accept the loan offer. If the consumer accepts the loan offer, the central facilitator may facilitate the release of the loan via one or more of the following modes: a bank account, a payroll account, Interbank Fund Transfer, Access Card, Manager's Check.

In some embodiments, the identifier is a mobile identification number.

In some embodiments, the whitelist information is in the format of at least one comma-separated values electronic file. In some embodiments, the central facilitator is operable to send a whitelist electronic notification to the consumer device upon determination that the at least one consumer is whitelisted.

In some embodiments, the whitelist electronic notification comprises a unique access code to access the central facilitator. The unique access code may comprise a Uniform Resource Locator (URL).

In some embodiments, the central facilitator is arranged in data communication with a telecommunications carrier.

In some embodiments, the central facilitator is arranged in data communication with a subscriber database and a short message service centre of the telecommunications carrier.

In some embodiments, the central facilitator is arranged in data communication with a user activity server to track and store activity data related to the at least one consumer.

In some embodiments, the activity data are correlated to a score associated with the borrower.

In some embodiments, the score is affected by at least one of the following factors: loan term, activity frequency, usage frequency, service frequency, historical credit behaviour, and comparison of at least one performance indicator in relation to a previously approved loan.

Another aspect of the invention relates to a method for aggregating a plurality of credit providers to provide credit to at least one consumer via a consumer device comprising an identifier associated with the at least one consumer, comprising the steps of: receiving at a central facilitator a request for credit from the consumer device; the request for credit comprises the identifier associated with the at least one consumer; receiving at a whitelist database arranged in data communication with the central facilitator, whitelist information from at least one of the plurality of credit providers; wherein upon receipt of a request for credit, the central facilitator instructs the whitelist database to compare the identifier with the whitelist information to determine if the at least one consumer is whitelisted, such that: if the at least one consumer is whitelisted, the at least one consumer is provided with a first electronic interface to complete an application for credit; if the at least one consumer is not whitelisted, the at least one consumer is provided with a second electronic interface for a plurality of identity checks.

In some embodiments, the method further comprise the steps of providing a network service provider arranged in data communication with the central facilitator and generating a verification token to be sent to the consumer device.

In some embodiments, the central facilitator comprises a credit provider interface to aggregate and generate information associated with each of the plurality of credit providers.

In some embodiments, the request for credit comprises a loan request, the loan request comprises a loan amount and loan term.

In some embodiments, upon receipt of the loan request, the method further comprises the step of simulating an amortization schedule based on the loan amount and the loan term.

In some embodiments, the method further includes the step of sending the simulated amortization schedule in an electronic form to the plurality of credit providers and the consumer.

In some embodiments, the method further comprises the step of logging the time each of the plurality of credit providers replies with a loan offer associated with the simulated amortization schedule.

In some embodiments, the method further comprises the step of selecting the credit provider that replies at the earliest time to be the successful credit provider to make a loan offer.

In some embodiments, the central facilitator is operable to send a second electronic notification to the consumer, the second electronic notification comprises the loan offer related to the successful credit provider, the central facilitator further operable to send a third electronic interface for the consumer to decide whether to accept the loan offer.

In some embodiments, if the consumer accepts the loan offer, the central facilitator facilitates the release of the loan via one or more of the following modes: a bank account, a payroll account, Interbank Fund Transfer, Access Card, Manager's Check.

In some embodiments, the identifier is a mobile identification number.

In some embodiments, the whitelist information is in the format of at least one comma-separated values electronic file.

In some embodiments, the method further comprises the step of sending a whitelist electronic notification to the consumer device upon determination that the at least one consumer is whitelisted.

In some embodiments, the whitelist electronic notification comprises a unique access code to access the central facilitator. In some embodiments, the unique access code comprises a Uniform Resource Locator (URL).

In some embodiments, the central facilitator is arranged in data communication with a telecommunications carrier.

In some embodiments, the central facilitator is arranged in data communication with a subscriber database and a short message service centre of the telecommunications carrier.

Another aspect of the invention relates to a non-transitory computer readable medium containing executable software instructions thereon wherein when installed and executed on a mobile device of a user, performs a method comprising the steps of: detecting on the mobile device an identifier entered by the user; sending the identifier to a central facilitator for processing; receiving from a central facilitator a verification code; identifying or determining if the user is a whitelisted user; prompting the user to select a loan provider; and wherein if the user is a whitelisted user, processing the user based on pre-qualified requirements.

### BRIEF DESCRIPTION OF THE DRAWINGS

The present invention will now be described, by way of example only, with reference to the accompanying drawings, in which:

FIG. 1 is a system diagram of a system for facilitating transactions in accordance with various embodiments of the invention;

FIG. 2 illustrates a user utilizing the system for facilitating loan transactions in accordance with some embodiments of the invention;

FIG. 3 illustrates a credit or loan provider submitting a pre-approved whitelist as part of the authentication process in accordance with some embodiments of the invention;

FIG. 4 is a flow diagram of one or more loan applications in accordance with some embodiments of the invention;

FIG. 5 is a flow diagram of an individual applying for a loan via his/her mobile phone or computing device in accordance with another embodiment of the invention;

FIG. 6 is a table showing the type and medium of notifications in relation to a loan application process sent to a user;

FIG. 7 illustrates a system block connection diagram between the client mobile device and the central facilitator in accordance with another embodiment of the invention;

FIG. 8 illustrates a process flow of a credit provider uploading a whitelist to the system in accordance with an embodiment of the invention;

FIGS. 9a and 9b illustrate the process flow of a loan application depending on whether the potential borrower is preselected or whitelisted for a specific loan product;

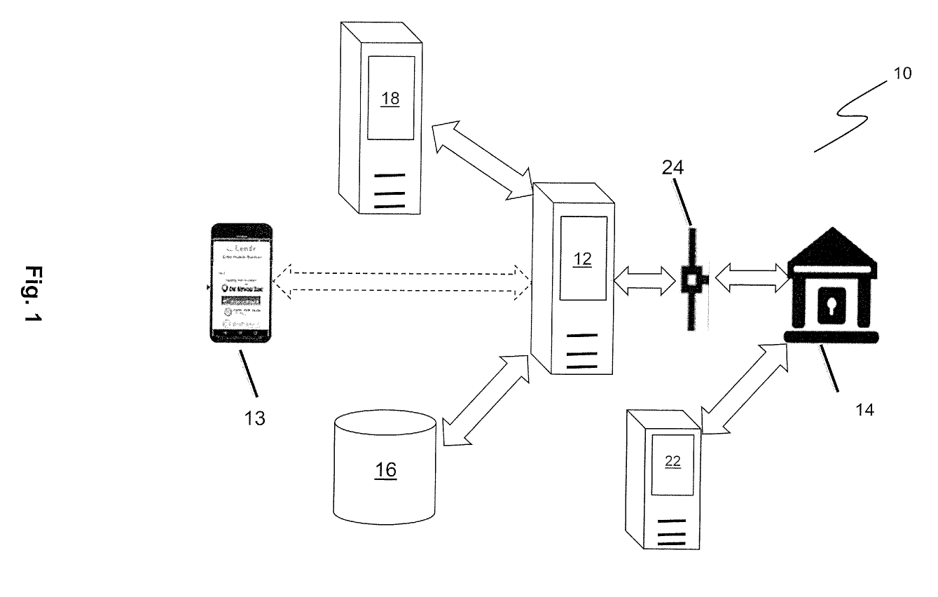

Other arrangements of the invention are possible and, consequently, the accompanying drawings are not to be understood as superseding the generality of the description of the invention.

### DESCRIPTION OF EMBODIMENTS OF THE INVENTION

In accordance with an aspect of the invention there comprises a system 10 for facilitating transactions such as loans. The system 10 comprises a fully-digital platform (hereinafter referred to as central facilitator 12) which aggregates different credit providers 14 such as financial institutions, banks or other credit/loan providers into a single “marketplace” for general public/consumers, as well as selected employees of private companies wishing to be availed or considered for loans. Such general public/consumers will be referred interchangeably with the term ‘potential consumers’ or ‘potential borrowers’.

The central facilitator 12 may be accessible via an online portal, a dedicated software application or interface hereinafter referred to as a ‘mobile app’ as colloquially known, or via electronic text messaging such as SMS, the destination address which may be made available to selected or general potential consumers. In some embodiments, potential consumers may have to meet certain criteria in order to be selected, for example meeting certain salary in order to be avail themselves to the credit providers.

Multiple interested credit providers 14 may be aggregated to the system 10 via being registered or linked to the central facilitator 12 via a registration process which includes provision of certain details which may include business registration identifiers or information tied to the credibility and reputation of the credit providers 14. In such embodiments, the central facilitator 12 is operable to perform a “Due Diligence Process” for the bank and company to determine the company's financial stability, presence, technical capability and other criteria deemed appropriate.

A credit provider 14 or an interested credit provider 14 may include one or more of the following:
A financial institution or a bank in the credit provision (lending) business
A private company with a set of employee/borrowers; and/or
A payroll company/provider nominated by the private company

To register or sign-up as a credit provider 14, a direct integration between the central facilitator 12 and the “host/banking system” of the credit provider 14, whether internal or external, is performed. Such integration may include the changing of destination portal address such that the credit facilitator 12 is linked to the destination address of the credit provider host system and vice-versa. In some embodiments, an institution handling the payroll and through a bank may carry out a salary loan program to their employees (of the private company) and ultimately the bank is the “creditor” or issuer of the loan.

In some embodiments, the credit providers 14 are loan providers and they may be linked/registered or authenticated to the system 10 in accordance with the following steps:
Each credit provider 14 undergoes a registration or sign-up process with the system 10 (and central facilitator 12) based on standard legal arrangements including non-disclosure agreements (NDA), Memorandum of association (MOA) etc;
Upon creation of an electronic account for the loan provider 14, a system integration between the central facilitator 12 and the loan provider 14 is established. Such system integration may include creation of secured data communication links between one or more servers of the loan provider 14 with one or more servers of the credit facilitator 12. One or more Web/Portal server, in the form of Web Application Server (WAS) may be utilized to facilitate data communication between the central facilitator 12 and the loan provider 14.
Connectivity or communication protocols are followed to ensure secure communication between banks and us e.g. VPN, leased line etc.

In some embodiments, the set-up of the credit providers 14 such as the financial institutions or banks can be handled on a per financial institution/bank and/or a per product engagement, therefore the system 10 (and central facilitator 12) can handle set-up for multiple products. For example, setting up different loan types or products such as a home loan, auto loan, and personal loan may happen at the same time and can be launched all together.

In some embodiments, a notification via email is sent to the financial institutions or banks when an electronic loan request or application of the consumer is received by the central facilitator 12.

In some embodiments, the financial institutions or banks can upload their own documents into the consumer's account maintained in one or more databases within the system 10 for centralization of the consumer's file. In this regard, the aggregation for the financial institutions or banks can be conducted in a single platform. Further, the system 10 can accept multiple loan requests for the same user or loan requests from different users at any given time and track at what stage the loans are at any point in time.

The system 10 may also be viewed as a system for aggregating a plurality of credit providers to provide credit to at least one consumer. The at least one consumer may hold one or more consumer devices 13 having an identifier associated with the at least one consumer. Such consumer devices 13 may include mobile phones, smartphones, tablet PC, etc.

The central facilitator 12 is arranged to receive a request for credit from the consumer device; the request comprises the identifier associated with the at least one consumer. In some embodiments, the identifier may be a mobile identification number such as a MIN/MSISDN associated with the consumer. In various embodiments, a whitelist database 16 may be arranged in data communication with the central facilitator 12, the whitelist database 16 may be further arranged to receive whitelist information from at least one of the plurality of credit providers 14. Therefore, the whitelist database 16 may be set up or configured for efficiency and maximization of the financial institutions or banks, since the whitelist database 16 may gather whitelist information from at least one of the plurality of the financial institutions or banks and classify the gathered whitelist information based on predetermined conditions (e.g. attribute of user profile) if necessary. In some embodiments, the whitelist database 16 may be a cloud-based database. In some embodiments, the data of the consumer is synchronized with the whitelist database 16 so as to allow only one nominated mobile identification number such as a MSISDN as his key access.

Upon receipt of a request for credit from the consumer device, the central facilitator 12 may instruct the whitelist database 16 to compare the identifier with the whitelist information to determine if the at least one consumer is whitelisted, such that: if the at least one consumer is whitelisted, the at least one consumer is provided with a first electronic interface to complete an application for credit; if the at least one consumer is not whitelisted, the at least one consumer is provided with a second electronic interface for a plurality of identity checks. The first and second electronic interface may be presented as user interfaces such as one or more websites or mobile app interface on the consumer device. The user interfaces include at least one of the following: the consumer's profile, the consumer's loans (for existing current or ongoing loans, after approval and acceptance/release), the consumer's applications (for all ongoing loan application stages until approval and release of loan) and an “Actions Required” menu which is a sub menu for any activity or requirement coming from the bank that the consumer needs to do in the course of the application. In some embodiments, the central facilitator 12 may pass the identifier to the whitelist database 16 for subsequent comparison.

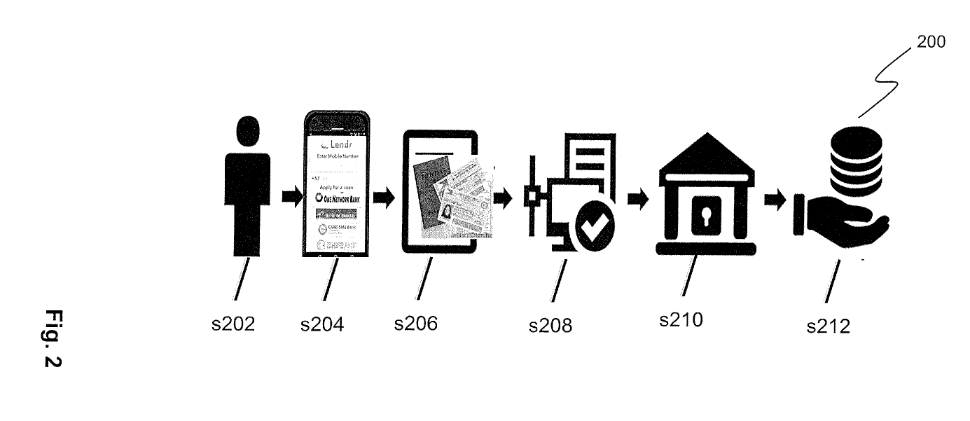

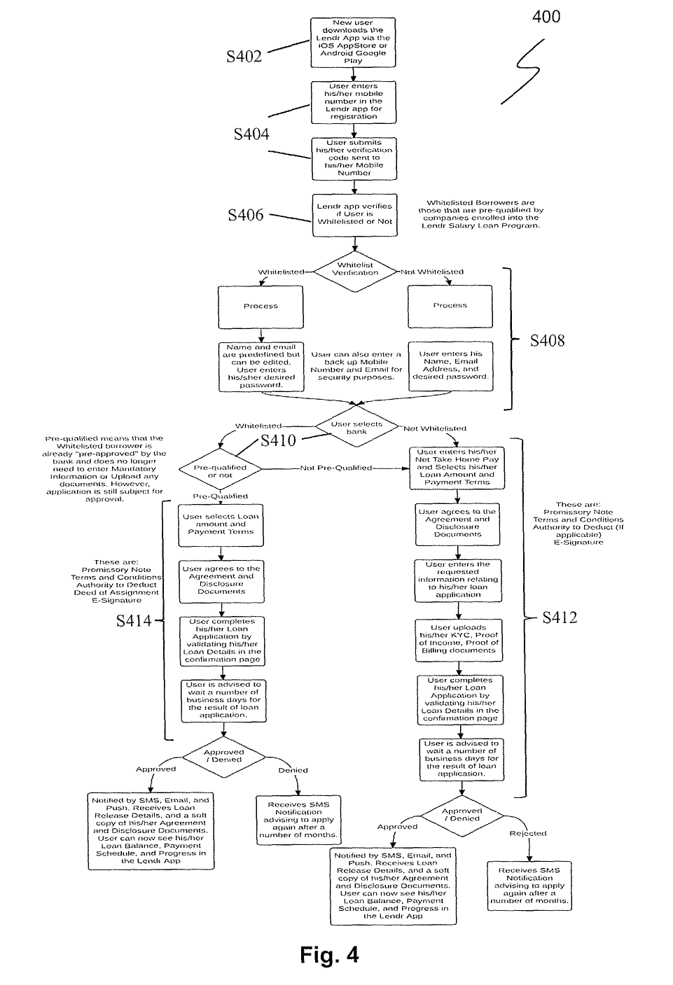

In an embodiment involving facilitation of loan transactions as illustrated in FIG. 2 and FIG. 4, a potential consumer may download a dedicated mobile software application (hereinafter mobile app) which is configured or arranged to interface and establish a data connection with the central facilitator 12 (step s202, s402). The mobile software application may be made available for download via an ‘app store’. The software application may comprise an electronic interface for the potential consumer to enter information or content relating to his identity, salary and financial records, etc. for creation of a new account and/or transmission of data and information to the central facilitator 12. The potential consumer or borrower to create his profile in the mobile app which is in turn installable and executable on a consumer device, such as, but not limited to, a smartphone. In some embodiments, the mobile app can be downloaded via accessing the central facilitator 12. In other embodiments, the mobile app may be downloadable from an online portal, using one or more consumer devices. In some embodiments, the potential consumer or borrower may either get a specific bank assigned link or proceed to a public link (e.g. Uniform Resource Locator) to download the mobile app. In some embodiments, one or more images may be uploaded to the mobile app as display pictures for the consumer. In addition, accessibility to the mobile app may be password protected with a user name.

If the potential consumer is a new customer, he creates an account (step s204) and enters the necessary information to proceed the creation of the account. One or more verification procedures may be made to establish that the potential consumer is registered. In some embodiments, the potential borrower will first need to enter an identifier as verification, such as his mobile number that will be validated by the central facilitator 12 (step s404). Secondly, the potential borrower will be required to nominate/create a password with some demographic data about the consumer. The data includes at least one of the following: city, area, gender, marital status, employment, and nationality. The potential borrower will need to enter his username and details, which may include an upload of the potential borrower's image or picture. A verification code (an OTP or electronic Know-your-customer or KYC) may also be sent as a text message or USSD message to the user's computer/mobile device to determine if indeed he is the one holding the mobile phone and applying. If he cannot send the code then he cannot proceed. In addition, the walk-in borrower will also need to electronically provide (e.g. scan and attach) the necessary documents along with the application. This information will have a credit checking on the bank's side which is their standard process like doing a call-back etc. to verify indeed if he is the one requesting for the loan.

An additional step of verification includes checking if the borrower is an existing “whitelisted” customer or a new customer (step s406). In some embodiments, another level of verification may be performed via an OTP (one-time-password) to be sent to the consumer once the consumer is already logged into the system via the mobile app for example.

Once logged in to the mobile app or portal, the consumer can begin checking the various products provided by one or more credit providers. The consumer can also customize and build his profile based on his loan requirements. The user profile includes at least one of the following: personal data, employment/business data, financial data, identification and document requirements and custom fields per specific institution or bank.

Once the account is created, the consumer then may then enter the necessary information and upload/furnish the necessary documents to complete a loan application (step s206). Once completed, the profile is ready and can serve as an “application data” to facilitate the completion of any request for loan and/or loan application in relation to any specific institution or bank which the consumer wishes to apply for one or more loan products.

With regard to the creation of the profile, in some embodiments, the profile of the consumer is created together with an upload of IDs and documents stored in the account (a one-time set-up of the account) which can be used every time the consumer avails himself to a loan. In some embodiments, a single interface ‘pipe or conduit’ connecting the financial institutions or banks and the Credit Bureaus of a specific country is provided utilizing the central facilitator 12 as the main interfacing platform. This may be performed via dedicated communication channels or means such as virtual private network (VPN) or other encrypted channels. Advantageously, a placeholder for a credit score from the Credit Bureaus of the specific country can therefore be provided for the creation of the profile.

In an example, once the consumer selects a loan offer from a specific institution or bank, and is matched, he will proceed to apply for a loan by clicking on an “Apply Button” displayed on the interface. He goes through the process of filling up the pertinent loan information until he completes the profile requirements for his loan. This includes the loan term, etc.

In other example, once the consumer selects a loan type/product, he will proceed to fill in required loan details (e.g. amount and term) on a loan calculator interface or page. A list of all specific institution or banks offering the loan type/product selected by the consumer (i.e. amortization amount for the selected term of loan) is displayed. Thereafter, the consumer selects one or more specific institution or bank from the list and clicks on an “Apply Button”. The consumer may be required to enter more information if the selected specific institution or bank require. The consumer need to agree terms and conditions provided by the selected specific institution or bank and may be required to affix e-signature of an actual signature of the consumer.

Once the consumer selects to accept the one credit provider (bank) for a particular loan type, he will not be able to apply for a similar loan in another bank offering the same product or loan type, e.g. a salary loan. He may, however, apply for another type of loan by commencing a separate application.

The borrower may be asked the option on how to release the loan (e.g. via credit to account, manger's check, bank pick-up etc.).

The central facilitator 12 next processes the received loan application (step s208). In this regard, the central facilitator 12 is configured to “pre-process” the loan based on the prequalification parameters set by the loan provider (such as a bank). There may be a real-time online checking performed by the system 10 for such a pre-processing step. In some embodiments where the consumer is an employee/member of an approved institution or company that has uploaded whitelist data to the whitelist database 16, the consumer may be screened to determine whether he is a whitelisted consumer (step s408).

In some embodiments, the system 10 also filters the credit providers that are eligible based on a set of qualification criteria of a particular institution or bank. Such qualification criteria may include assets of the institution, reputation etc.

Based on the whitelist information, the central facilitator 12 will be able to pre-process the loan according to some predetermined logic. Such predetermined logic may form part of the whitelist information. The whitelist information may include employment and salary data of employees in a company together with a set of logic (such as a rule-based algorithm) for allowing a loan. Using such whitelist information, the system 10 is able to “pre-compute” or calculate at the point of application whether a borrower will be pre-qualified based on the initial screening. Given the criteria or requirements provided by the company, the system 10 will also pre-compute the allowable, maximum loan amount of the borrower. If the borrower does not meet an essential criteria based on pre-screen, he may be rejected right away. In some embodiments, the central facilitator 12 of system 10 may also determine if the borrower is indeed in the prequalified list (whitelist) before proceeding. If the borrower is not in the whitelist, he will not be allowed to participate via the “bulk” or “whitelist” route, although the borrower may still participate as a normal member (step s412).

In some embodiments, potential borrowers (customers) would have been screened and whitelisted with their personal and salary information already logged in the central facilitator deposited in a user database (step s414).

In some embodiments, there comprises an optional facility for the central facilitator 12 to access one or more databases associated with a country or geographical region's credit bureau. This will enable one or more credit providers to perform checks on the credit background of the borrower. The information is confidential and will only be relayed to the approving credit provider(s).

After the loan is processed or filtered by the central facilitator 12, the loan application is submitted to the credit provider, by completing a set of terms and conditions, as well as electronically signing an electronic application form (step s210).

In some embodiments, once one bank has approved the loan, the other banks are notified of the status of the borrower's application through a Management console provided to the banks. The management console may be provided by the central facilitator 12, the credit provider 14, or other servers as described in earlier embodiments or may be a separate server. The status will contain details on the fact that the loan was approved (but not yet accepted) by the bank with date and timestamp.

In some embodiments, the selected specific institution or bank are notified via email of incoming loan requests. The mobile app/site is updated in the borrower's account and each status is also updated into the account until it is approved. In the meantime, SMS notifications are sent to the borrower for each stage. Once one bank has approved the loan, the notification advising the approval is sent to the borrower. The borrower may login to the mobile app/site to check his approved loans. The borrower will need to accept the loan or reject the loan if he is not amendable to the terms and amount approved. Once accepted, the loan will move into a booked status until the loan is disbursed and will switch to released status.

In some embodiments, if the selected specific institution or bank require more information and/or documents from the borrower in order to approve the loan, a function called “More Information” is invoked. The “More Information” function allows the selected specific institution or bank to gather more information vie preset data fields and more documents (as indicated by the selected specific institution or bank) for the borrower to upload into the system 10. The borrower receives a notification from the mobile app/site under an “Actions Required” menu/interface for example and an SMS message regarding the additional requirements of the selected specific institution or bank and replies with the required fields and documents and submits. The loan application is tagged as “Submitted” again, and the selected specific institution or bank proceed to re-process the loan application.

In some embodiments, an account for a potential consumer may be created using the unique identifier associated with the potential consumer, such as a mobile identification number (MIN) of the potential consumer. The identifier MIN or MSISDN associated with a borrower's telecommunications carrier account may be used at the point of the borrower or loan account creation. MIN is used as the reference to point or link to the borrower or loan account. It may also be the key access with password to access the mobile app after download. In some embodiments, a secondary authentication for the first time users creating the account through an OTP (one-time password) will be sent to the registered mobile number (MIN).

The creation of a consumer or customer account may include secure or authentication steps as follows:
The mobile number (MIN or MSISDN) is validated by a corresponding telecommunications network provider that may be arranged in data communication with the central facilitator 12. The telecommunications network provider or carrier may comprise network elements such as one or more Short Messaging Service Centers (SMSC), SMTP servers, subscriber databases;
An one-time password (OTP) or e-KYC may be sent to verify the borrower (who is presumably holding the mobile device associated with the MIN) being used/registered;
There may comprise an additional feature to upload an actual image (such as a photograph) of the person borrowing which can form the basis of further review/authentication by the bank.

The MIN may be considered to be the unique key (like a National ID) of an individual in engaging and interacting with the central facilitator 12. The MIN serves as a form of tokenization, representing an individual without revealing sensitive account data like the account number, for example. The MIN may be regarded as a unique identifier for associating to the person owning it. Additional security measures via a password and an OTP are added to the MIN request before loan transactions may be processed.

It is to be appreciated that multiple security features aside from the usual username and password may be utilized. The mobile number of a potential borrower's mobile device may be utilized as a form of tokenization and two-factor authentication (2FA) via OTPs from creation of account to the actual loan transactions. In some embodiments, the mobile number acts as the reference or key to enter the system. It has a password linked to it. The real account Number or PN (Promissory Note) number is not divulged to the loan provider. In addition, an OTP (one-time password) for financial transactional activities is sent to the potential borrower to ensure that he is the one utilizing the account.

In some embodiments, the consumer, once authenticated in the system may be tracked on ‘performance’. The central facilitator 12 may be configured to track the performance. Alternatively or in conjunction, there may comprise a user activity server 18 arranged in data communication with the central facilitator 12 to perform the tracking function and store the necessary activity data. As the borrower account matures the system collects data that can be correlated to a “scoring” mechanism in terms of being a “GOOD” account member. Non-exhaustive examples of factors affecting the ‘score’ of the borrower's account may include:
Tenure (loan term)
Activity/Usage/Service frequency
Historical credit behavior and performance against his previously approved loan using the system. For example, the system may track how many reminder payments the person gets or the number of past due notifications sent is indicative of how he is performing against his loan account In some embodiments, the score may be an indication of a risk of default for subsequent loan or credit applications.

In some embodiments, the system 10 comprises a historical database 18 for storage of historical loan data associated with all loans for all consumers. All existing loans may be disclosed to other credit providers or banks, in compliance with data privacy laws to ensure no over-drawn or over-booked loans happen. This may be part of the terms and conditions for the borrowers to agree on.

In some embodiments, the system 10 may be interface with one or more online or web portals for data communication to online applications. In some embodiments, the system 10 may interface with an email server, with SMTP architecture for email notifications. In some embodiments, the system 10 may be linked or integrate with one or more credit providers' loan system, accept from and send information to the credit provider's server/portal and loans database. The central facilitator 12 may be configured to allow text, mobile app and web-based inquiry of loan balances. In summary, as the functions associated with the system 10 may be modularized, the system 10 can be configured as a whole suite or can be integrated with the credit provider(s) in modules depending on the credit providers' requirements for set-up.

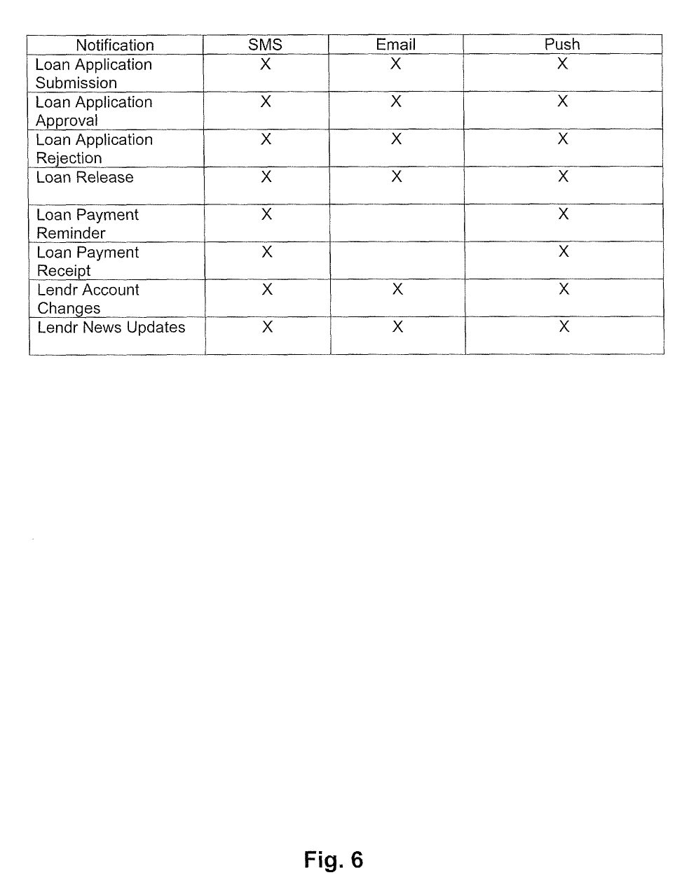

In terms of the loan application process, a consumer can apply through the following end-to-end loan origination processes via the following combinations/modes SMS with online application; Full online application (via the Portal); via the mobile app; Interfaces with the Mobile Application; Interfaces with the Portal for Online Applications; Integration with the SMTP architecture for email notifications (see FIG. 6); Interface with text-based loan payments; accept from and send information to the bank's server/portal and Loans database; interface with a telecommunications carrier's SMS centre and database; allow text, mobile app and web-based inquiry of loan balances; and interface with text-based loan payments.

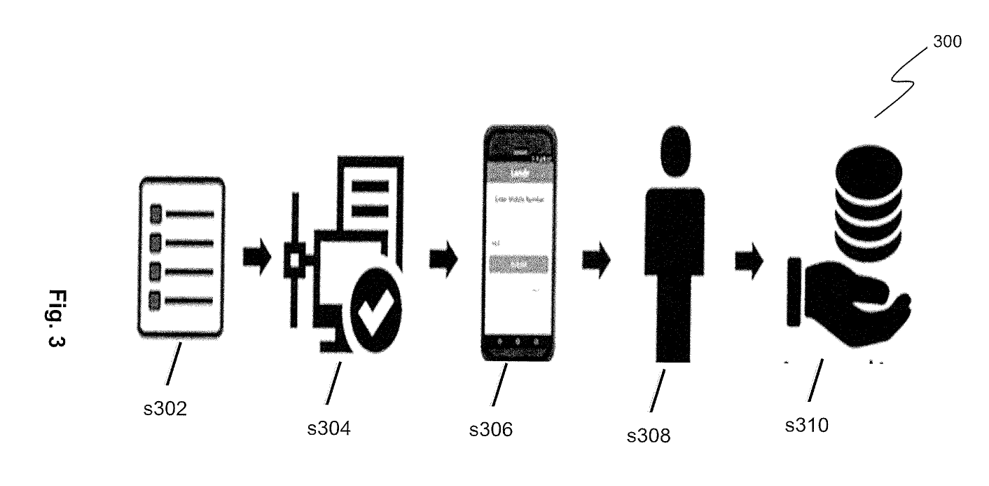

FIG. 3 illustrates a specific embodiment illustrating the process 300 where a credit provider, in the form of a partner bank, may upload a whitelist for example, to avail a loan or credit to a whitelisted (pre-qualified) borrower (step s302).

A loan application may be submitted via two different methods, i.e. via an individual loan application performed via Mobile App/web portal, or via bulk application through a company or payroll account. With reference to FIG. 3, the central facilitator 12 is arranged in data communication with credit provider in the form of a private company, payroll institution or bank to create, maintain and access the system 10 to upload an electronic list of potential borrowers of the bank for “payroll”/salary accounts, instead of the credit provider processing the upload. This eliminates the step for hand-offs and files being sent to the bank (step s304). In this embodiment, the whitelist may contain pertinent details of the employees of the company and may include all demographic data, contact information, salary details (gross pay, net take home etc.) as well as other personnel information. As an additional step, the whitelist may be certified by one or more authorized personnel before submission to the lending bank.

In some embodiments, the payroll company or private company may be given access to upload a list of employees who meet one or more criteria. Once uploaded, the employees are eligible as “pre-qualified” borrowers. Borrowers will be notified via electronic notifications such as SMS (for SMS-based applications) or push notifications (Application Status) relating to the availability of the loan to them. They will be provided with their “company code” which may be required when they apply for the loan (if via SMS).

The process via “mobile application” in the entire process, serves as the first electronic step for the employee/borrower to signify their intention to avail of the loan program.

Once the whitelist have been uploaded and duly verified, the central facilitator 12 is ready for validation of employee/borrowers (step s306).

To make an electronic loan request, the employee/borrower may send an SMS with the following message syntax:

Type “LEND <space> EMPLOYEE NUMBER <space> COMPANY CODE” and send to xxxx (the central facilitator destination code).

Once the central facilitator 12 receives the loan request, it will validate the message sent by checking with the whitelist database and if it meets the validation and appears in the “whitelist” database, the central facilitator 12 will send a confirmation reply to the borrower. The reply message may be in the form:

“Thank you. You have been pre-qualified under the Loan Program. A link will be sent to your registered email address to complete your application. Your Passcode for the online application is XXXXXX. Thank you.” (Date) (Ref #)

The borrower will need to enter this “passcode” to access a secure online form to complete his loan application (step s308). It is to be appreciated that the link may be an electronic web address and may be a URL link unique for each potential consumer/borrower.

Once the passcode is entered, the borrower will be able to access the online form via the URL link sent to his email address. After entering the passcode sent to the borrower's consumer device such as mobile phone, the potential borrower will be brought to an electronic interface that displays one or more online application screens the borrower needs to complete only two types of information for this loan to be fulfilled, the same being the intended loan amount and the intended loan term. The intended loan term may be, for example, 12, 24, 36, 48 or 60 months.

The system 10 comprises logic to pre-compute the loanable amount for the borrower based on the salary details provided by the company. Based on at least the salary details, a cap is set as to the borrower's maximum loanable amount for his application.

After the borrower decides on two inputs, the central facilitator 12 will calculate the indicative and projected net loan proceeds, (which will be the net loan amount after all charges and other fees have been deducted).

The borrower may also be asked to click an “I Agree” interface button for all the Term & Conditions, Disclosure Form, Promissory Note and the other required forms available also online, and signing off on the loan via the e-Signature section before clicking on the “Submit” button.

Once the loan request is submitted to the central facilitator 12, processed and submitted to the bank, the bank may require the potential borrower to undergo the loan credit process of the bank. Alternatively, the bank may have approved it and thus only have the function of crediting the loan proceeds based on the borrower's designated mode (step s310).

The borrower also has the option to print the entire form if he wants retain a copy.

In some embodiments, where the whitelist has been uploaded and the notification to the potential borrower has been transmitted, the borrower may either download the mobile app or access a portal. The system 10 compares against the whitelist database 16 to ascertain that he has been preloaded and/or is a new applicant. Since this is a “bulk” process, the pre-qualified new applicant will be diverted to create an account with the central facilitator 12 if he is interested to avail himself of the loan.

If the borrower is a new applicant, he proceeds to create a new account with the central facilitator 12 as described in FIGS. 2 and 4. As the borrower already has his preloaded information with the central facilitator 12, he will just create his username password into the system through a validation process using the MIN with his telecommunications carrier account as described.

Upon logging on, the borrower proceeds to input or select the loan amount, loan term as well as the option on how to release the loan (e.g. via credit to account, manger's check, bank pick-up etc.)

The borrower then proceeds to submit the loan application form using the interface provided by the mobile app or portal, complying with all the necessary terms and conditions, promissory note requirement etc.

In some embodiments, the credit provider may need to perform manual approval of the loan requests; the following features may be applicable.

The bank's authorized personnel, such as loan processor/officer accesses an interface (i.e. a Management console) provided to the bank and views all applications. This allows the loan processor to process all submitted application forms. He then reviews the loan and does the internal checking on the borrower. If the borrower passes the credit checking he will process the loan in the system as “processed” and locks in the loan details. The workflow approach is for this to be sent for final approval of the bank manager.

The physical process using the Management Console provided to the bank, allows for a final check on the loan online, before approving it. The bank manager accesses the Management console provided to them, and checks on all loan applications processed for his review.

In some embodiments, the system 10 may comprise a loan approval server arranged in data communication with the credit provider 14 allows the bank manager/loan approver to approve or reject the loan applications submitted to their bank. This loan approval server may also be configured to send SMS notifications and Email Notifications to the borrowers of their Loan Status.

These electronic notifications contain reference numbers, terms and conditions, details of loan etc.

In some embodiments, the system provides a loan credit server (with necessary network elements) arranged in data communication with the credit providers to release a borrower's loan via his/her preferred option for a loan release method. For Whitelist applicants where their companies have uploaded details, crediting will only be through the borrower's payroll account. Upon release of the loan, the borrower may receive an electronic notification in the form of SMS message, Email, or Push notification from the mobile app. In some embodiments, the list of loan release methods may be via credit to payroll account (for whitelisted borrowers only); credit to designated savings account (for walk-in or non-whitelisted borrowers); Interbank Fund Transfer (for walk-in or non-whitelisted borrowers); Issuance of Access Card; Manager's Check.

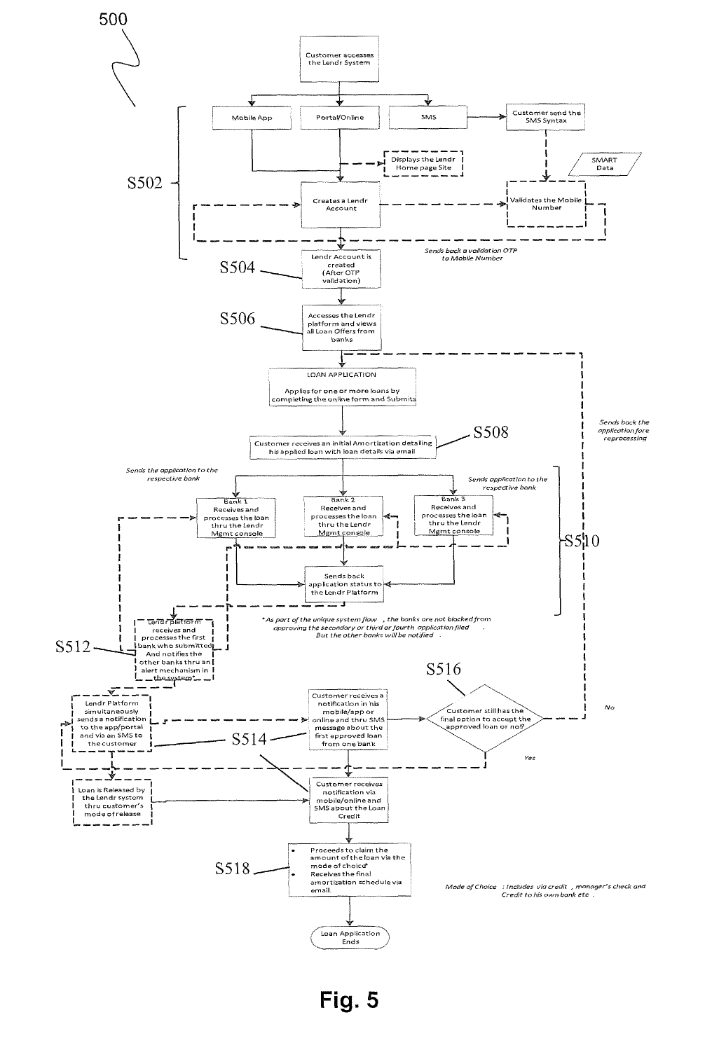

FIG. 5 describes a process 500 illustrating another embodiment where potential consumer/borrowers access the system 10 to perform loan requests and multiple loan providers capable of accepting the loan requests to make loan offers. The process highlights the feature of aggregating a plurality of credit providers (banks, financial institutions) to provide credit to at least one consumer, the consumer may be either a whitelisted consumer or otherwise. The process begins with the access to the central facilitator interface via mobile app, portal or SMS message, with the necessary validation steps and creation of account where necessary, as described (step s502). Once the consumer or potential borrower is logged on to the system 10, he accesses the platform and view various loan products from the credit providers (step s504). The consumer may then complete the necessary application details for one or more loan applications (step s506).

The system 10 accepts multiple loans applications/requests at any given time and is able to track at what stage the loans are. The loan requests may be electronically transmitted to the credit providers 14 via the management console or may be electronically transmitted to the central facilitator 12. Upon receipt of the multiple loan requests, the multiple loan providers may make corresponding loan offers and submit the same to the central facilitator 12 for further process. As there are multiple loan offers, each loan offer is time stamped and logged by the central facilitator 12. In some embodiments, the fastest bank that approves the loan application (by making the loan offer) would be successfully processed by the central facilitator 12 (step s512). The other banks are notified of the status of the loan applications with first bank, and may still have the options to approve succeeding loan applications. Critical to the multiple loan acceptance process are the time stamps or logs associated with to determine first and successful approver.

In some embodiments, the borrower is also electronically notified of the status of his loan application(s) at every step of the process. This is a unique feature to proactively communicating in a closed-loop, secure method to provide transparency and efficiency (step s514).

In some embodiments, after the successful bank makes the loan offer, the customer is provided a chance to reject or not accept the loan in case he does not agree to one or more terms (e.g. loan amount) that was approved (step s516). If the customer rejects the loan offer, further negotiations/offers may take place (back to step s506).

The system 10 can cater to two kinds of borrowers. Firstly, by utilizing any of the existing set-up of a bank's depository payroll base, the central facilitator 12 provides an individual borrower, access to a salary or personal loan product backed by his payroll account. By doing this “bulk” approach, once the whitelist is entered into the system, an individual borrower is automatically created an account with the central facilitator and thus being already in that list, can loan anytime, anywhere through a mobile app installable on a smartphone or online via a web portal. Secondly, for customers who are not ‘whitelisted’ (i.e. ‘walk-in’ customers), the central facilitator may cater to such individual “walk-in” customers as well, not requiring to be connected in any whitelist or bulk application. The interested individual can just download the mobile app from a smartphone and apply for the loan.

In some embodiments, the central facilitator 12 allows borrowers to select a bank with the best rate, and borrowers can apply loans remotely from anywhere.

In some embodiments, the central facilitator 12 provides a loan payment server 22 arranged in data communication with a bank to process a borrower's loan payments. The bank can either dispense a single payment for one borrower or to process bulk payments for a group of borrowers. Upon processing of loan payment, the user database in data communication with the central facilitator 12 will update the borrower's account with the central facilitator 12 and send electronic notifications via SMS and/or push.

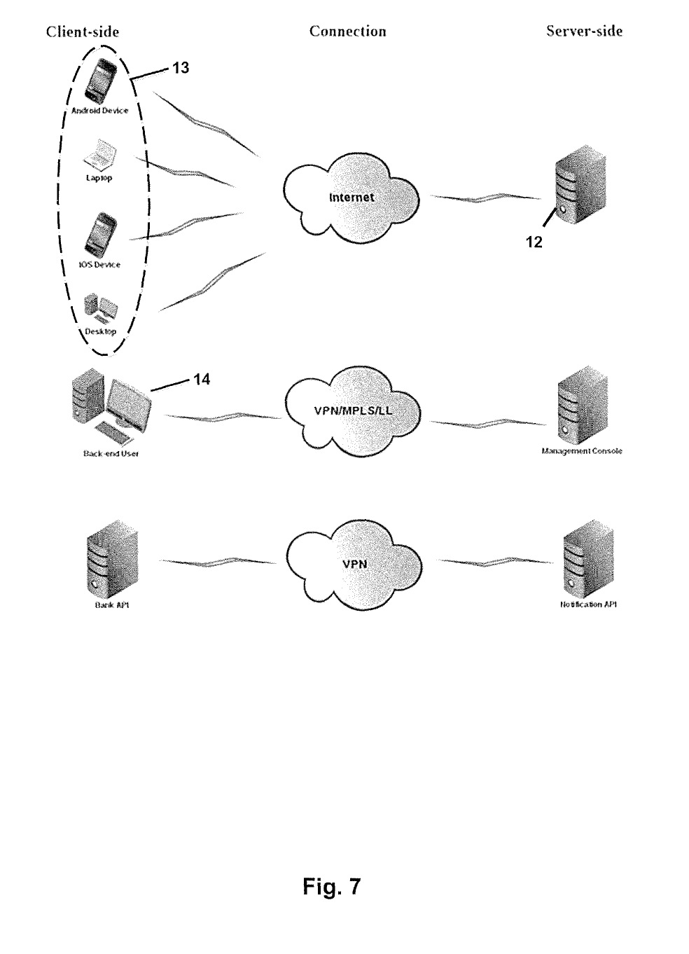

In some embodiments as shown in FIG. 7, the data connections and/or data communication links between the central facilitator 12, financial institution 14 and potential consumers 13 are illustrated. In particular, backend communication i.e. credit providers/banks with central facilitator 12 are typically via relatively more secured communication links relative to front-end communication i.e. consumers 13 with central facilitator 12.

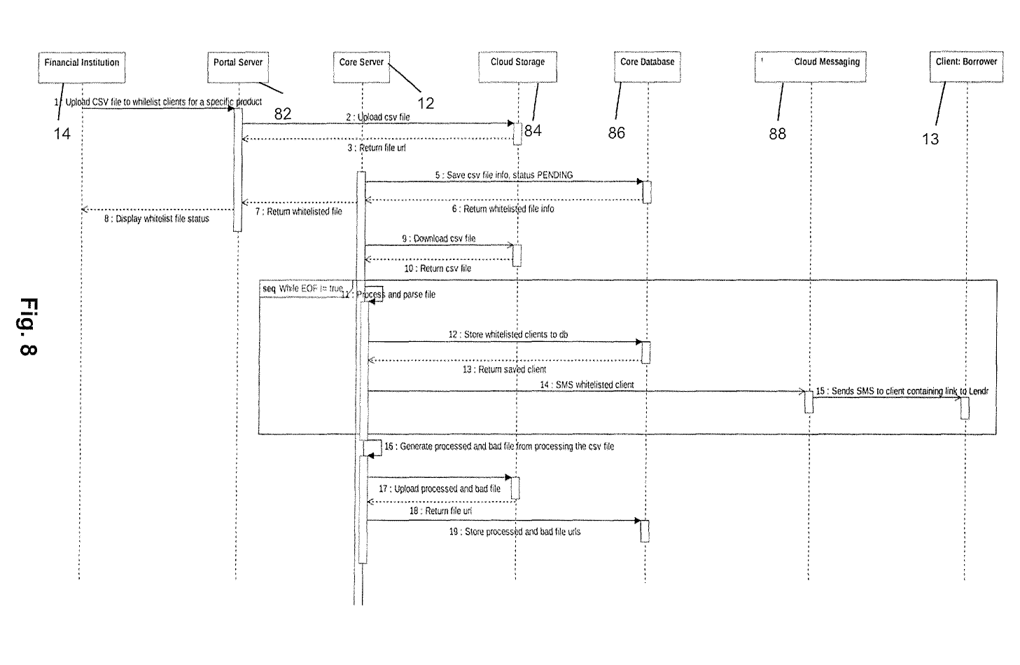

An embodiment of how a credit provider 14, such as a financial institution, uploads a whitelist in a comma-separated value (.csv format) file containing the data of whitelisted users for a particular loan product is illustrated in FIG. 8. A portal server 82 is arranged as an interface server between the financial institution 14 and central facilitator 12. The central facilitator 12 is in turn arranged in data communication with a cloud storage 84 and core database 86. A cloud messaging server 88 is arranged to receive electronic instruction from the central facilitator 12 to send SMS messages to one or more parties. The portals server 82 uploads the csv file to the cloud storage 84 and sends the resulting link (URL) to the central facilitator 12. The central facilitator 12 downloads the csv file, parses, and save the information to the database 86. Whenever a new potential consumer/borrower has been whitelisted, the central facilitator 12 sends an SMS via the server 88 to the potential borrower. The SMS may contain a link for the consumer to create an account with the system 10 or to apply for loan. The link is uniquely generated for each whitelisted potential borrower. On every processing of .csv file, the central facilitator 12 generates a processed and a bad file and stores them in the cloud storage 84.

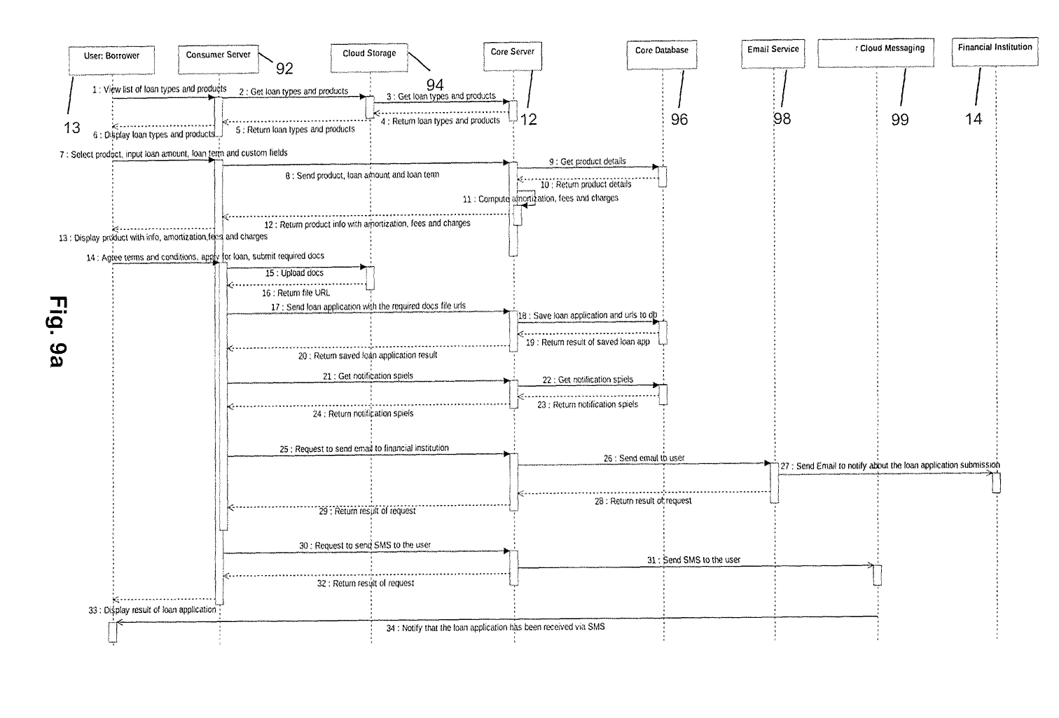

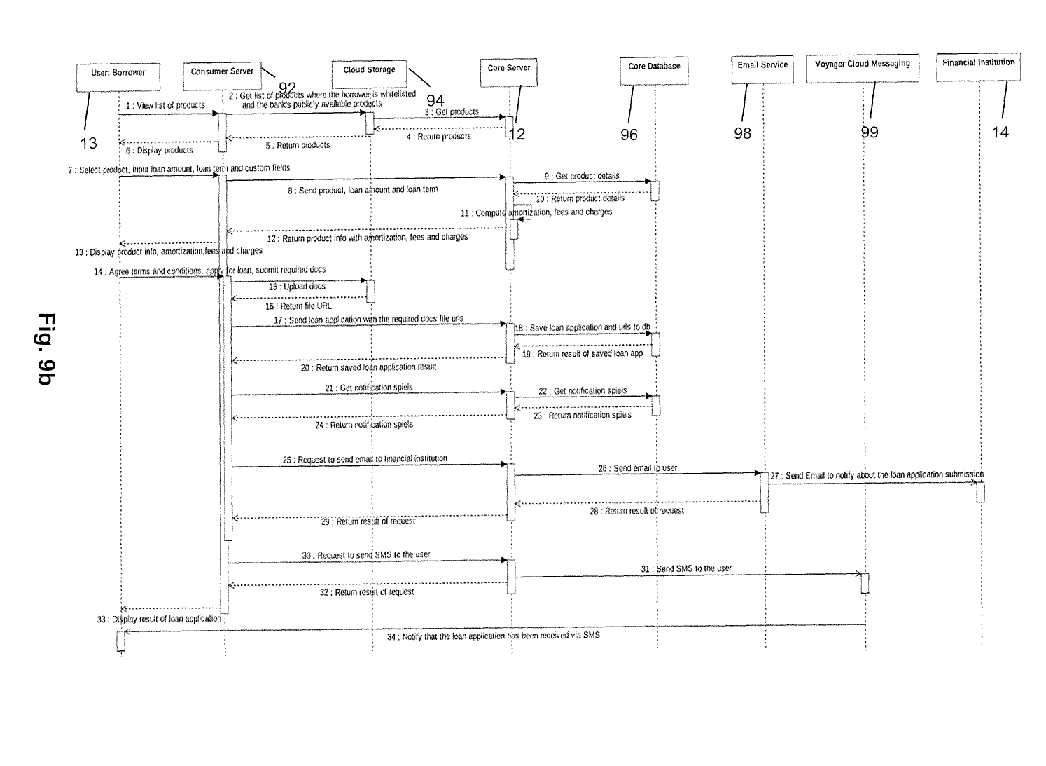

FIGS. 9a and 9b illustrates the data flow for a borrower who utilizes system 10 for loan application. The borrower selects a product type and input the desired loan amount and term in a consumer server 92 arranged in data communication with the central facilitator. The consumer server 92 then sends the data to the central facilitator 12 which in turn collates and match the loan product given the parameters, computation of the amortization schedule, fees, charges, and storage of the data to a core database 96. The central facilitator 12 returns the list of collated and matched products with computed figures to the consumer server 92 for the borrower's review. Depending on the loan product, the borrower may be required to upload supporting documents. The consumer server 92 uploads such supporting documents to a cloud storage 94 and sends the resulting URL link, together with the loan application request of the borrower to the central facilitator 12. After the consumer server 92 receives a confirmation of loan application submission from the central facilitator 12, it sends a request to the central facilitator 12 and send an electronic notification (email) via an email server/service 98 to the financial institution about the submission of the loan application. An SMS may be sent to the borrower for notification of the loan application submission via a cloud messaging service 99.

The borrower in FIG. 9a has not been whitelisted while the borrower in FIG. 9b has been whitelisted for the specific loan products. As such, in FIG. 9b there is no collation and matching of loan product as the same has already been predetermined.

In some embodiments, instead of wholly managing the loan requests, the central facilitator 12 may provide a loan management server or interface 24 arranged in data communication with a credit provider 14 to allow the credit provider to manage the loan requests. The loan management server or interface 24 comprises various components as follows for a bank to adjust various parameters associated with a loan.

Loan adjustment component—allowing a bank to adjust, add or remove additional fees to the borrower's loan application before approval and release. This is to cater for any additional fees that may be bank specific.

Loan application cancellation component—allowing the bank to cancel an ongoing Loan Application upon the respective borrower's request. This is after a loan application is submitted to the bank but has not yet been approved. This is subject to the bank's assessment and/or the borrower's request.

Loan reversal component—allowing the bank to reverse an already approved loan application before the loan is released or immediately after the loan is released. This is subject to the bank's assessment and/or the borrower's request.

Report generation component—allowing the bank to generate and download standard reports for their business purposes, such as but not limited to: Daily Statistics of Loan Application Submissions, Approval, Rejection, Release, and Payments; Cumulative Statistics of Loan Application Submissions, Approval, Rejection, Release, and Payments; Profile of borrower's with Active Loans; Name; MIN; Email; Principal Amount; Payment Term; Interest; Current Loan Balance; Next Payment due Date.

Statement of Account Generation component—allowing a borrower to request for his/her Statement of Account in relation to his/her loan/s. Upon request, the Statement of Account will be sent to the borrower's email. The borrower may also request for a hard copy of the Statement of Account with a corresponding processing and delivery fee.

Pre-termination component—allowing the bank to terminate an ongoing loan before its maturity date. This will also calculate the sum amount the borrower must pay to fully pay for his/her debt upon request of pre-termination by the borrower.

The Renewal/Auto-Renewal component—allowing the bank to set/tag existing loans for auto-renewal or for manual renewal. Once tagged for renewal and upon its maturity, the loan may be re-applied following the same loan amount (or can be higher if salary details changed),terms, and interest rate (following the bank's current rate).

Loan restructuring component—allowing the process of extending the terms of the borrower's active loan. Additional rates and fees, set by each specific bank, will be applied to the extended loan.

In some embodiments, the central facilitator provides for one or more user interface to retrieve relevant data from one or more databases on request by a consumer (typically a borrower) as follows:

Loan balance inquiry feature—allows a borrower to request for the current outstanding balance of his/her loan. This can be done via SMS or by simply accessing the mobile app or portal via the user interface.

The following information may be sent to the borrower upon SMS Inquiry:

Current outstanding balance; Next payment due date; Next payment due amount.

Loan payment inquiry feature—will enable borrowers to retrieve his/her payment history.

The following information may be sent to the borrower upon SMS Inquiry—Total Amount to be paid (Principal+Interest); Payment Progress (eg. 13/24 payments paid); Next Payment Due Date; Next Payment Due Amount.

History feature—displays a user's activities and applications made since the creation of the account. This may be accessed via the mobile app or portal.

The following information may be displayed upon access of his/her history

Account Profile Changes (eg. password, email, account number, etc); Loan Applications (Approved or Rejected)

Loan calculator feature—allows a user to simulate an amortization schedule based on his/her desired Loan Type, Loan Amount, and Loan Term. This provides the user with a quick overview of the possible payment schedule he/she will have to commit based on the provided variables. The calculator should be able to display the following—eligible banks; monthly payments; minimum income required (If available)

Notification feature provides borrowers with timely information regarding their account with the central facilitators, loan applications, and updates/promos.

Notifications can be sent via SMS, Email, and Push.

Within the mobile app and portal there may comprise an ad space where the banks can upload promotional content for their Loan Products.

Credit ranking inquiry feature—allow borrowers to use the Lender system to retrieve their current credit score from the partnered credit bureau. The Lender user will receive an email containing his/her credit score information within the advised waiting time.

Social platform—the system may contain other information that will be useful to the borrower. Such information could be social media blogs regarding loans, financial practices, savings, etc.

Loan Transfer feature—allows a current loan with Bank A to be transferred to Bank B. This request will be subject to the assessment of both banks and will follow a strict process.

Loan Migration feature—allows a user to migrate his/her existing loan not processed under the system 10 to the system 10. Upon migration, the loan should now be displayed as one of the active loans in his/her Account with the central facilitator 12 where loan-monitoring tools will be available.

The salient advantages of the inventions are as follows:

Through the linking up with a plurality of credit providers with the central facilitator 12, a potential borrower is only required to set up one account with the central facilitator 12 to gain access to various banks and financial institutions integrated/registered with the central facilitator. Potential borrowers can check their balances anytime, anywhere through the mobile app or online.

The platform provides an end-to-end flow of transaction of the loan from application to loan release, using only the mobile device or web-portal, without requiring the user to physically go to the actual bank of choice. Such transactions may be facilitated via network elements and telecommunications carriers.

A borrower can manage multiple loans in his account with the central facilitator 12 across different loan types and number of loans.

The system is telecommunications network agnostic and is technically capable of linking with any telecommunications carrier locally and abroad subject to contractual/compliance requirements. The product can likewise handle SMS-based or Mobile App-based processing.

Credit decision may be obtained real-time, online (for whitelist) and individual (for walk-ins).

The system offers an approach where multiple credit providers can have a chance to offer their products through the system and central facilitator to the majority of potential loan borrowers. With the ability to tie-up with one or more telecommunications carriers and multiple credit providers, a mobile-enabled loan origination processing capability is offered that can either use the system or be able to link/integrate with any loan system that credit providers may already have. The system creates “fair competition” and monitoring whereby the loans are prioritized depending on the banks offerings, which are presented transparently but at the same time, be able to lock the loan to whichever bank processed the loan application.

It should be appreciated by the person skilled in the art that variations and combinations of features described above, not being alternatives or substitutes, may be combined to form yet further embodiments falling within the intended scope of the invention.

1. A system for aggregating a plurality of credit providers to provide credit to at least one consumer comprising
a consumer device comprising an identifier associated with the at least one consumer;
a central facilitator arranged to receive a request for credit from the consumer device; the request comprises the identifier associated with the at least one consumer;
a whitelist database arranged in data communication with the central facilitator, the whitelist database further arranged to receive whitelist information from at least one of the plurality of credit providers;
wherein upon receipt of a request for credit, the central facilitator instructs the whitelist database to compare the identifier with the whitelist information to determine if the at least one consumer is whitelisted, such that:
if the at least one consumer is whitelisted, the at least one consumer is provided with a first electronic interface to complete an application for credit;
if the at least one consumer is not whitelisted, the at least one consumer is provided with a second electronic interface for a plurality of identity checks.

2. The system according to claim 1, further comprises a network service provider arranged in data communication with the central facilitator to generate a verification token to be sent to the consumer device.

3. The system according to claim 1 or 2, wherein the central facilitator comprises a credit provider interface to aggregate and generate information associated with each of the plurality of credit providers.

4. The system according to claim 3, wherein the request for credit comprises a loan request, the loan request comprises a loan amount and loan term.

5. The system according to claim 4, wherein upon receipt of the loan request, the central facilitator is operable to simulate an amortization schedule based on the loan amount and the loan term.

6. The system according to claim 5, wherein the central facilitator is operable to send the simulated amortization schedule in an electronic form to the plurality of credit providers and the consumer.

7. The system according to claim 6, wherein the central facilitator is operable to log the time each of the plurality of credit providers replies with a loan offer associated with the simulated amortization schedule.

8. The system according to claim 7, wherein the credit provider that replies at the earliest time is selected to be the successful credit provider to make a loan offer, and the central facilitator is operable to send a first electronic notification to the successful and unsuccessful credit providers.

9. The system according to claim 8, wherein the central facilitator is operable to send a second electronic notification to the consumer, the second electronic notification comprises the loan offer related to the successful credit provider, the central facilitator further operable to send a third electronic interface for the consumer to decide whether to accept the loan offer.

10. The system according to claim 9, wherein if the consumer accepts the loan offer, the central facilitator facilitates the release of the loan via one or more of the following modes: a bank account, a payroll account, Interbank Fund Transfer, Access Card, Manager's Check.

11. The system according to claim 1, wherein the identifier is a mobile identification number.

12. The system according to claim 1, wherein the whitelist information is in the format of at least one comma-separated values electronic file.

13. The system according to claim 12, wherein the central facilitator is operable to send a whitelist electronic notification to the consumer device upon determination that the at least one consumer is whitelisted.

14. The system according to claim 13, wherein the whitelist electronic notification comprises a unique access code to access the central facilitator.

15. The system according to claim 14, wherein the unique access code comprises a Uniform Resource Locator (URL).

16. The system according to claim 1, wherein the central facilitator is arranged in data communication with a telecommunications carrier.

17. The system according to claim 16, wherein the central facilitator is arranged in data communication with a subscriber database and a short message service centre of the telecommunications carrier.

18. The system according to claim 1, wherein the central facilitator is arranged in data communication with a user activity server to track and store activity data related to the at least one consumer.

19. The system according to claim 18, wherein the activity data are correlated to a score associated with the borrower.

20. The system according to claim 19, wherein the score is affected by at least one of the following factors: loan term, activity frequency, usage frequency, service frequency, historical credit behaviour, and comparison of at least one performance indicator in relation to a previously approved loan.

21. A method for aggregating a plurality of credit providers to provide credit to at least one consumer via a consumer device comprising an identifier associated with the at least one consumer, comprising the steps of:
receiving at a central facilitator a request for credit from the consumer device; the request for credit comprises the identifier associated with the at least one consumer;
receiving at a whitelist database arranged in data communication with the central facilitator, whitelist information from at least one of the plurality of credit providers;
wherein upon receipt of a request for credit, the central facilitator instructs the whitelist database to compare the identifier with the whitelist information to determine if the at least one consumer is whitelisted, such that:
if the at least one consumer is whitelisted, the at least one consumer is provided with a first electronic interface to complete an application for credit;
if the at least one consumer is not whitelisted, the at least one consumer is provided with a second electronic interface for a plurality of identity checks.

22. The method according to claim 21, further comprise the steps of providing a network service provider arranged in data communication with the central facilitator and generating a verification token to be sent to the consumer device.

23. The method according to claim 21 or 22, wherein the central facilitator comprises a credit provider interface to aggregate and generate information associated with each of the plurality of credit providers.

24. The method according to claim 23, wherein the request for credit comprises a loan request, the loan request comprises a loan amount and loan term.

25. The method according to claim 24, wherein upon receipt of the loan request, the method further comprises the step of simulating an amortization schedule based on the loan amount and the loan term.

26. The method according to claim 25, further comprises the step of sending the simulated amortization schedule in an electronic form to the plurality of credit providers and the consumer.

27. The method according to claim 26, further comprises the step of logging the time each of the plurality of credit providers replies with a loan offer associated with the simulated amortization schedule.

28. The method according to claim 27, further comprises the step of selecting the credit provider that replies at the earliest time to be the successful credit provider to make a loan offer.

29. The method according to claim 28, wherein the central facilitator is operable to send a second electronic notification to the consumer, the second electronic notification comprises the loan offer related to the successful credit provider, the central facilitator further operable to send a third electronic interface for the consumer to decide whether to accept the loan offer.

30. The method according to claim 29, wherein if the consumer accepts the loan offer, the central facilitator facilitates the release of the loan via one or more of the following modes: a bank account, a payroll account, Interbank Fund Transfer, Access Card, Manager's Check.

31. The method according to claim 21, wherein the identifier is a mobile identification number.

32. The method according to claim 21, wherein the whitelist information is in the format of at least one comma-separated values electronic file.

33. The method according to claim 32, further comprises the step of sending a whitelist electronic notification to the consumer device upon determination that the at least one consumer is whitelisted.

34. The method according to claim 33, wherein the whitelist electronic notification comprises a unique access code to access the central facilitator.

35. The method according to claim 34, wherein the unique access code comprises a Uniform Resource Locator (URL).

36. The method according to claim 21, wherein the central facilitator is arranged in data communication with a telecommunications carrier.

37. The method according to claim 36, wherein the central facilitator is arranged in data communication with a subscriber database and a short message service centre of the telecommunications carrier.

38. A non-transitory computer readable medium containing executable software instructions thereon wherein when installed and executed on a mobile device of a user, performs a method comprising the steps of:
detecting on the mobile device an identifier entered by the user;
sending the identifier to a central facilitator for processing;
receiving from the central facilitator of claim 1 a verification code;
identifying or determining if the user is a whitelisted user;
prompting the user to select a loan provider; and wherein if the user is a whitelisted user,
processing the user based on pre-qualified requirements.
